(19) United States
(12) Patent Application Publication
(10) Pub. No.: US 2015/0174935 A1
(43) Pub. Date: Jun. 25, 2015

(54) Rubber Stamp Block

(71) Applicant: Christine Schmidt, San Francisco, CA (US)

(72) Inventor: Christine Schmidt, San Francisco, CA (US)

(21) Appl. No.: 14/139,896

(22) Filed: Dec. 24, 2013

(51) Int. Cl. B41K 1/56; B41K 1/04

(52) U.S. Cl. CPC B41K 1/56; B41K 1/04

(57) ABSTRACT

A rubber ink stamping block for relief printing comprising a rigid central block having a first flat surface on a first side of said block and at least one rubber block secured thereto and preferably recessed from the outside edges thereof. The rubber block preferably comprises at least two opposing flat and parallel sides and is secured on a first flat side of the central block by adhesive or other fastening means. The rubber block is adapted to be carved on the exposed flat side by a carving tool in a conventional linoleum cut manner, creating depressions and land areas; the land areas between the depressions retaining ink and transferring the same when pressed onto a surface, like paper. Preferably, a second rubber block is provided also secured to the rigid block on the opposite side thereof from the first rubber block.

### FIELD OF THE INVENTION

The present invention relates to a simple manual block for use in hand stamping, stamp carving and relief printing. Specifically, it relates to a wood block (other materials can be used, of course, as the holder of the print-making material) comprising at least one rubber-like carvable block secured thereto. Preferably, both sides of the wood block are provided (preferably by adhesive) with carvable rubber blocks. The rubber block(s) are adapted to be cut using a standard knife or one or more cutting tools. Using such a tool, segments of the rubber block can be removed, creating a groove or an indentation in the rubber corresponding to the shape, length, and depth of the piece(s) removed. One or more segments of the rubber block can be removed using the cutting tool(s), and an artistic design can be provided to the surface of the rubber block(s) as desired by the Artist. Once segments of the rubber block have been removed, a design is “left behind” by the combination of remaining flat sections of the rubber block and the removed segments. The remaining uncut portions of the block are then provided with ink for repetitive printing. By placing ink atop the cut rubber block to achieve a smooth, thin layer of ink thereon, such as by use of a paint roller, the k will preferably coat all segments of the rubber block which remain uncut (the flat sections) and no ink will be provided to the grooves or cut out sections. Hand-pressing the inked rubber block onto a piece of paper or other surface (wall paper, plaster board, gift wrap, etc.) for receipt of the ink, a fanciful, artistic design will be transferred from the block to the recipient paper by the inked uncut portions of the rubber block. Of course, pressing the rubber block will transfer the ink to the paper and the gouged out or removed areas of the design in the rubber block will be a component of the design, too, in between the uncut portions of the rubber. The process is akin to traditional linoleum or wood cut printing but the wood block with dual-sided, originally flat rubber blocks secured thereto, to allow the Artist to create two different designs (by cutting out and gouging each of the rubber blocks) secured to a single, easily manipulated wood block, is the basic invention disclosed herein.

### BACKGROUND OF THE INVENTION AND DISCLOSURE

Stamp carving, stamp engraving, or linoleum block printing is a form of relief printmaking. Relief printing is a reductive process, i.e., a design is formed by the removal or carving out of portions of an originally flat stamping block. An image can be carved or engraved into a block made of linoleum, wood, rubber, or other materials using one or more carving, cutting or gouging tools. Ink can then be applied to the remaining flat surface of the block either by pressing the same into an ink pad or using a brayer (which is like a paint roller made of rubber) to apply printing ink thereto. Using an ink pad or a paint roller, the uncut areas of the block (which are raised above the cut-out portions) will be coated with ink, while the areas which have been carved away, subsequently becoming depressions into the block, do not receive ink. Once the un-cut portions of the block are coated with a thin layer of ink, the block can be pressed, ink-side down, against a sheet of paper or other material, and the image or “print” becomes visible as the ink transfer onto the paper, i.e., the ink and the cut-away pieces together provide the visual design of the block. Unlike drawing, which is an additive process, stamp carving is a reductive process. That which is cut away will not receive ink and will remain as the same color as the paper upon which the block is pressed while the flat sections of the block, not cut, will receive the ink and transfer onto the paper.

The present invention preferably comprises one or more rubber carving blocks connected, by some adhesive mechanism, to a rigid central mount for support. Preferably the rigid mount is a wood or linoleum block. The rubber blocks can be glued, taped, secured by Velcro® fastener, or any other adhesive. The wood canal block mount is adapted to hold the flexible rubber block while the same is being carved to prevent movement of the rubber and an undesired cutting of the same. Rather, the solid wood block securing the rubber block provides a secure and stable surface allowing for quite precise cutting of the rubber block. Also, since in the preferred embodiment the wood block has a pair of opposed rubber blocks secured to opposite faces of the wood block, one rubber block can rest on a flat work surface, like an artist bench, and frictionally hold the device in place, while the upwardly extending rubber block can be cut or gouged with precision, since there is little movement or “give” to the device on the work table, i.e., it is secure in its position because of the use of a stiff wood block holder and the rubber surface on the opposite side, i.e., the side in contact with the work table. Use of the rigid mount (the wood block) is adapted to provide greater accuracy with carving tools and a more precise resulting carved image. Additionally, the rigid mount provides an added level of safety for a user who is holding the device in his/her hand for cutting in that an additional surface is provided for placement of the artist's non-cutting hand while keeping the same away from the work surface being carved with sharp cutting and gouging tools. This helps to prevent accidental cutting of one's hand while using a cutting tool. Additionally, by holding the rubber block in place to keep it from moving while being cut, there is a lower likelihood that a cutting tool will slip and accidentally nick the user's non-cutting hand because un-mounted rubber has a “give” to it and can stretch or bend when being carved. The present invention aims to avoid several problems with using a block of rubber to create a printing block.

The rigidity of the wood mounting block also serves to provide a flat and even surface for the rubber block, i.e., one which has a uniform thickness. This allows a rubber block with parallel sides to sit flatly atop the wooden mounting lock without one edge of the rubber block being slightly raised above or depressed below the other side. This allows for uniformity and precise rubber block cutting and also allows the top surface of the rubber block (minus any cut-away depressions) to receive an even coat of ink once dabbed into an ink pad or applied with a roller. Without the rigid wood mount holding the rubber block in place, the inherent flexibility of the rubber may prevent an even coating of ink on the uncut portions of the rubber, and may unintentionally allow ink to seep into areas (which have been purposefully carved away) to be covered with ink. This in turn could affect the uniformity, clarity and precision of the print image when the rubber and ink are pressed onto a piece of paper.

The rigid wood mount preferably includes a pair of opposed finger grooves along the outer edges which are adapted to provide ease of gripping of the same by fingers on the non-cutting hand of a user and, of course, help to use the carved rubber block, as intended, as a printing device. As briefly described above, the rigid, central wooden mount, and specifically the finger grooves on the outer edges, provide finger gripping surfaces upon which an artist/user can place his or her fingers of his/her non-cutting hand to prevent accidental cutting of the same by a cutting tool. Use of the finger grooves also allow the fingers placed therein to apply pressure to the rigid block and therefore in turn to place even hand pressure on the inked rubber block when being pressed against a sheet of paper to produce the desired image.

In the preferred embodiment, a thin layer of extra rubber may be provided atop the rubber blocks. Preferably, this thin extra layer of rubber is approximately 1/16 of an inch thick, and is preferably a different color than the underlying relatively thicker rubber block. The use of a distinct extra color of thin rubber provides an easier visualization of the carved-away portions of the rubber block. That is, if the top layer of rubber is a lighter color than the rest of the rubber block, the image in the cut-away portions will appear in a darker shade than the un-cut portions, allowing easier visualization of the same. However, having the extra and distinct color layer also made of rubber, indeed, likely the same composition of rubber, maintains the uniformity of the printed image as the compressibility of the entire block, when pushed onto or against paper will be uniform.

While the present invention discloses use of a rigid central mount, preferably wood, with a rubber block attached thereto for carving, the preferred embodiment of the present invention comprises the use of two separate and distinct rubber blocks secured to a central rigid wooden mount. Preferably a first rubber block is attached to a first flat surface of the rigid wooden mount, and a second rubber block is preferably attached to a second and opposed flat surface of the rigid wooden mount. Each rubber block can be secured to the rigid wooden block by the same or a different securing mechanism, likely some form of adhesive. The first flat surface and second flat surface are preferably on opposing and parallel sides of the rigid wooden mount. By using two separate and distinct rubber blocks on the opposed sides of the central wood mount, each block can be separately carved, using a carving tool, into a different and potentially distinct design for creation of multiple printed images. The use of the rigid central wooden mount with opposed finger grooves located thereon yet between the rubber blocks also provides a surface for a user to grip the same without having to hold either rubber block This is convenient for cutting the rubber blocks and for printing.

### DESCRIPTION OF THE PRIOR ART

To the Applicant and inventor's knowledge, no prior art exists which provides a rubber block for stamp carving which is first secured to a rigid wooden block for stabilization and holding of the same. Additionally, no prior art is known which comprises a holding device for stably holding one or more independent and distinct rubber blocks, each adapted to be carved and coated with ink for printing of separate, distinct relief printing designs. Additionally, to the Applicant's knowledge, prior art relief printing is done with larger blocks of at least 4×6 inches. The present invention presents a rubber block which is preferably smaller than a standard rubber stamp inkpad's inking surface (which is approximately 3⅞×2¾ inches). The small size of the rubber block and attached rigid wood mount allows the block to be easily and completely coated with ink when dabbed in a standard size inkpad while also being small enough to allow a single hand of a user, preferably holding the finger grooves of the rigid mount, to apply enough pressure to the block to form a uniform and attractive relief impression on a sheet of paper from the design created by the cut-out portions of the rubber. The size of the wood block holder, with the rubber block(s) secured thereto, also allows for ease of carving as the wood block can easily be held in one hand while the artist carves/cuts with the tool held in the other hand. Also, the use of opposed rubber blocks secured to a central wooden block, when placed on a work table, results in a frictional holding of the block during the cutting phase and, yet, the block is not clamped down by mechanical holders so that the artist can easily pick it up and inspect the same, with minimum delay and loss of time.

Most printing blocks in the prior art known to the Applicant require a printmaking press because the larger surface area of the block requires a greater pressure than a human hand to create a clear impression or print. Many larger printing blocks are not provided with rubber blocks on both opposed surfaces nor provided with easy to grab finger recess-gripping surfaces.

### SUMMARY OF THE INVENTION

A stamping block for relief printing is provided. The present inventive block is for ink stamping of carved images, used by an artist and basically comprises a rigid block, preferably wood, comprising a first flat surface on a first side of said block and at least one rubber block secured thereto. The rubber block preferably comprises at least two opposing flat and parallel sides and is secured on the first flat side of the wood block by a securement means preferably an adhesive. The rubber block is adapted to be carved on its exposed, opposed second flat side by means of one or more carving tools. These tools are used to cut, scrape, gouge out material from the rubber block, leaving and creating surface depressions and leaving those areas of the rubber block between the surface depressions as the original flat surface of the rubber block. In the preferred embodiment, a second rubber block is provided, secured to the rigid wooden mount on the opposite side thereof from the first rubber block. Thus, in this embodiment, the wooden mount or wood block central section is sandwiched between two opposed rubber blocks. Each exposed face of the rubber blocks can be carved to show a relief design for ink printing.

Like the first rubber block, the second rubber block is provided with two opposing flat and parallel planar sides, one secured to the central wooden block and its parallel and flat face, with the other adapted to be carved using a carving tool for creation of a relief rubber surface useful in ink printing, like a linoleum block.

In the preferred embodiment of the present invention, a thin layer of rubber—preferably of a different color—is layered atop each of the exposed faces of the rubber block to allow easier visualization of the cut-out portions of the rubber block based on the color differentiation in the rubber. Also, in the preferred embodiment, the wood block is sized so as to be able to be held in the hand of the artisan which allows the device to be easy for cutting and for precise location and pressure for printing. Also, the present invention contemplates that the wood block have opposed finger grooves to facilitate the manual manipulation of the same, during cutting, inking and printing.

### BRIEF DESCRIPTION OF THE DRAWINGS

FIG. 1 is a top and perspective view of the present invention, a stamp carving block, showing one of two rubber blocks adhered atop a central rigid wooden block;

FIG. 2 is a side elevational view of the present invention seen in FIG. 1, showing the central and rigid wooden block with two, opposed and separate rubber blocks secured on both sides of the wooden block. The wooden block is shown with a longitudinally extending (from front to rear) finger cut-out or recessed trough or segment for ease of holding during cutting and to also aid in the application of pressure to apply ink to the stamp block and to facilitate the uniform transfer of the ink from the rubber block to a piece of paper;

FIG. 3 is a front elevational view of the present invention shown in FIGS. 1 and 2, and showing the central wooden block with rubber blocks on both side thereof and with the finger cut-out recess, extending along the outer surface of the wooden block, the Figures showing the rubber blocks in their “new” condition, i.e., prior to an artist creating any grooves, cuts or recesses therein; and

FIG. 4(a) is a front and side perspective view of the present invention seen in FIGS. 1, 2, and 3, showing only a single rubber block secured to one side of the rigid wooden block;

FIG. 4(b) is a front and side perspective view of the present invention seen in FIG. 4(a) with the rubber block having been cut, carved and gouged by tools, to show a design between the uncut portion of the rubber block and the removed portion of the rubber block so that when ink is rolled onto the uncut portion of the rubber block, and the ink is transferred to paper, the cut-out portions of the rubber block can be seen as a design in the absence of ink and the remaining portions of the rubber block showing the design of transferred ink; and

FIG. 4(c) is a front and elevational view of the present invention seen in FIG. 4(a), showing a thin layer of rubber provided atop a relatively thicker section of the rubber block, preferably of a different color rubber, for ease of visualizing the portions of the rubber block which have been cut away and those which remain, all to facilitate cutting and gouging by the artist.

### DETAILED DESCRIPTION OF THE DRAWINGS AND PREFERRED EMBODIMENT

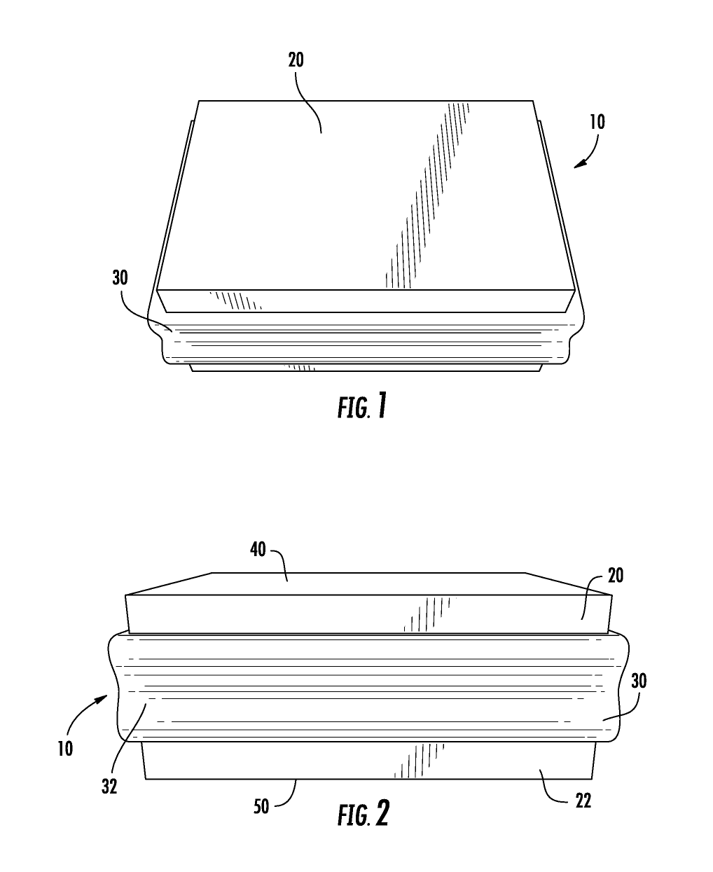

Description will now be given of the invention with reference to the attached FIGS. 1-4c. It should be understood that these figures are exemplary in nature and in no way serve to limit the scope of the invention as that will be defined by the claims issued in a U S patent, as interpreted by the Courts.

FIGS. 1-3 show the preferred embodiment of the present invention, an inkable rubber stamping block 10 for use by an artist in ink transfer and relief printing. FIG. 1 is a top and side perspective view of the stamp block 10. Stamp block 10 comprises a rigid central block body 30, preferably made of hard wood, which has at least one rubber block 20 secured to a planar surface of the block body 30. Rigid block body 30 preferably has at least two opposing flat planes or parallel sides for having one or more rubber blocks 20 secured thereto. As can be seen, a first rubber block 20 can have one of its planar sides secured, preferably by adhesive, to a first side or planar surface 25 of the rigid block body 30. It is envisioned that the securement means can be glue, tape, Velcro®, or any other adhesive.

First rubber block 20 has two opposing, flat and parallel surfaces 27 and 29. One surface 27 is adapted to be secured to the planar surface 25 of the rigid central wood block 30. The other surface 40 is adapted to be carved using a carving tool. When portions of the rubber block 20 are cut, gouged or scraped away, a design is created between the created surface depressions created in the rubber block 20 and the remaining planar surface 40. Once a desired design is created by an artist from the rubber block 20, ink can be applied to the surface of the block either by pressing the same into an ink pad or using an ink roller. The uncut areas of the block (which are relatively raised above the cut-out portions) receive a thin coat of ink, while the areas which have been carved away, now surface depressions, do not obtain ink. The rubber surface is ink-absorbent to obtain and retain ink as the same is rolled or pressed onto its surface. Yet, as can be expected, the rubber block 20 allows for the ink to be easily transferred from it to paper when the same is placed into relative contact. This produces the desired design onto paper. Once the un-cut portions of the block are coated with a thin layer of ink, the block can be pressed, ink-side down, against a sheet of paper or other material, and the image or “print” seen as being provided with ink appears on the paper with the cut-away pieces of the rubber block being provided with no ink, i.e., those areas remain unprinted upon by ink and the color of the paper is seen.

Preferably, rigid wood block 30 is provided on its two opposed faces with two separate and distinct rubber blocks 20 and 22 (see FIG. 2). Each rubber block 20 and 22 is provided with two planar parallel and flat sides, one of which is secured to the opposed, parallel and planar sides of the rigid block 30. Free side or planar surface 40 of rubber block 20 is one surface for the artist to create a design while free end 50 on rubber block 22, adhered to the opposed side of the wood block 30 can accept a second artist's design. The rubber blocks are adapted to be carved using one or more carving tools. The rigid wood block 30 is sandwiched between the adhered rubber blocks 20 and 22 and provide a rigid holder while designs are carved into the rubber blocks. The hard central wood block serves to prevent slippage and slight rubber block movement during the cutting steps. This is important to ensure accuracy and precision of the design(s). This also reduces the chances of an inadvertent cut of the rubber which is not intended to be part of the design, and also reduces the likelihood that the flexibility of the rubber will cause the carving tool to slip and accidentally cut the non-cutting hand of the user or a part of the rubber block intended to be uncut. The hard central wood block 30 also allows for uniform application of ink when the same is placed on an ink pad or rolled with ink and allows for uniform application of pressure for transference of the design onto paper.

Rigid preferably wood center block 30 is preferably provided with longitudinal extending, recesses or finger grooves 32 extending from one flat face to the opposed flat face. These finger grooves are on opposite edges of rigid wood block 30. The finger grooves 32 provide a purchase location for placement of the fingers (four on one side, the thumb on the other) of a user's non-cutting hand. The finger grooves 32 are thus located distal from the rubber blocks 20 and 22 as they are being carved, which eliminates the need for a mechanical holder for the rubber blocks. The finger grooves also serve to reduce the possibility for one to accidentally nick his or her fingers while attempting to carve the rubber. The finger grooves also provide an excellent finger purchase for the artist to use in gripping the same for inking and printing.

Use of rigid, wood, central block 30 also provides a set of planar, flat and parallel surfaces for placement of the rubber blocks 20 and 22. The flat parallel surfaces of the wood central block act to ensure that the rubber blocks are substantially even all across the top surfaces 40 and 50. This prevents ink, when dabbed or rolled onto the uncut portions of the rubber blocks, from dripping or seeping into the cut-out portions not intended to receive ink. If ink gets into the cut-out portions, it will affect the clarity, precision and the design intended to be printed, as the block with ink is pressed onto paper.

A goal of this basic form of relief printing is to form an image from the portions removed from the block and the remaining spaces there between of the block, the latter receiving the ink. The gouged or cut our portions do not receive the coat of ink. In the preferred embodiment, where two separate and distinct rubber blocks 20 and 22 are provided, with each rubber block itself comprising two flat and parallel surfaces, the central rigid block 30 acts to maintain the top surface (40 or 50) of the block intending to be carved at a parallel and flat angle, thus preventing accidental seeping of ink into the cut-away portions of the block. The parallel and opposed rubber blocks also provide the artist with a simple to use block for cutting, gouging, etc. More specifically, the use of a rubber block on both sides of the wooden central block means that one rubber block can be cut with tools while the other rubber block can sit directly upon a work table. The rubber block, facing downwardly (not being then carved) will, as a consequence of the rubber surface and its inherent friction, cause the block, especially when presented with downward pressure, as when cutting or gouging is being done, to remain in position. Thus the two sides of the wooden block, provided with rubber blocks, makes a very easy to cut and gouge printing block. When one side is worked upon, the other side, covered with a rubber block, helps to hold the block and the upwardly facing rubber block, in relative position.

According to the invention's preferred embodiment, the rubber blocks are recessed inwardly form the sides and edges of the central wood block so that ink which is placed on the non-cut areas of the rubber block will not necessarily come into contact with the user, when inking and printing. By recessing the edges of the rubber block inwardly from the perimeter of the central wood block, the user/artist is less likely to have his/her hands sullied by ink.

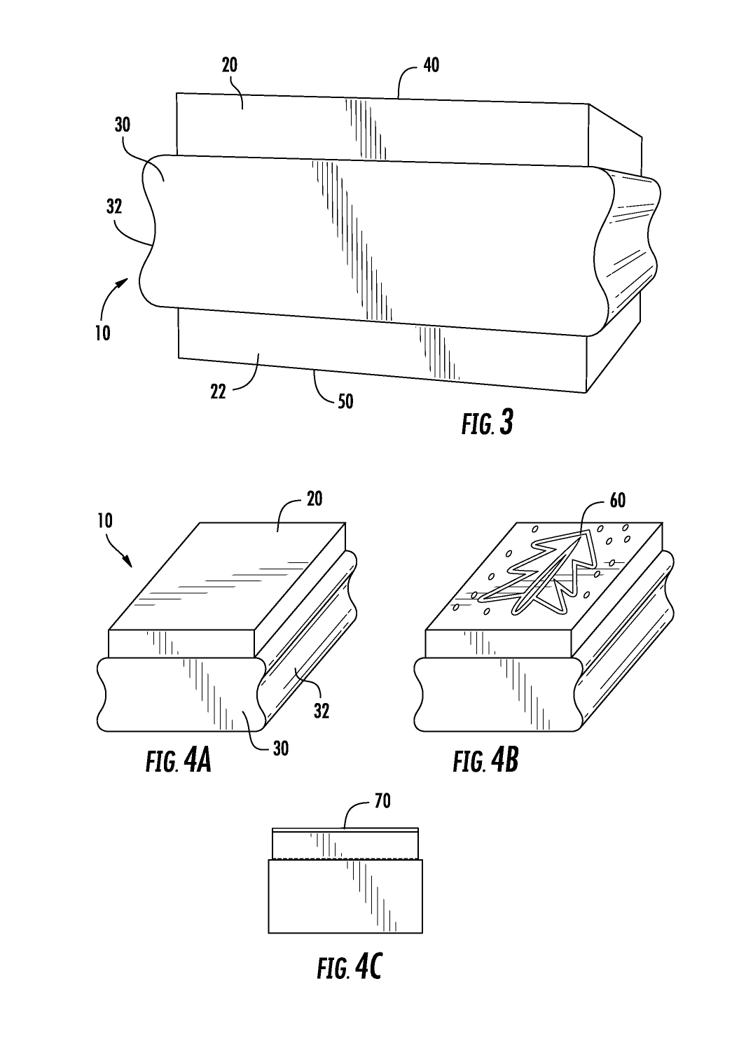

FIG. 4(a) is an alternate embodiment of the present invention showing stamp block 10 with rigid wooden mount 30 and a single rubber block 20 secured thereto, i.e., only on one face of the central block. While the preferred embodiment of the present invention contains two separate and distinct opposed rubber blocks 20 and 22, it is envisioned that the present invention can be provided with only a single rubber block 20, as seen here. FIG. 4(b) shows the stamp block 10 shown in FIG. 4(a) with the top surface 40 having been carved by suitable tools—the cut-away portions 60 creating the design of a Christmas tree and falling snow. When ink is rolled or dabbed onto the top surface of the rubber block 20, and the block is subsequently pressed against a piece of paper, canvas, or other surface, the design of the Christmas tree and falling snow will be visible as seen by the absence of ink formed in that design. This reductive printing and design making is well known to those of skill in the art.

In the preferred embodiment of the present invention, an additional thin layer of rubber 70 is provided atop each of the top surfaces of the rubber block 20. Preferably, this thin layer of rubber 70 is approximately 1/16 of an inch thick, and more preferably a different color rubber than the rubber block 20 should be provided. The alternate color rubber provides a visual mechanism for a user/artist to appreciate, quickly, easily and accurately the cut-away portions of the rubber block, as the image formed in the cut-away portions will appear in a different color of rubber (the beneath rubber block color) than the un-cut portions on the top, thin surface layer 70.

It will be understood by those of ordinary skill in the art that various changes may be made and equivalents may be substituted for elements without departing from the scope of the invention. In addition, many modifications may be made to adapt a particular feature or material to the teachings of the invention without departing from the scope thereof. Therefore, it is intended that the invention not be limited to the particular embodiments disclosed, but that the invention will include all embodiments falling within the scope of the claims.

What is claimed:

1. A block for use in the process of reductive design and repetitive ink stamping comprising:
a rigid, central block of about the size of a hand, comprising a first substantially flat surface on a first side of said block; and
a rubber block comprising at least two opposing flat sides, said first flat side being secured to said flat surface of said block and said opposed second flat side of said rubber block being carvable by a carving tool, the carving tool adapted to create surface depressions in said second flat side of said first rubber block while leaving intact the non-carved surface of said second flat side of said rubber block.

2. A block for stamping as claimed in claim 1 wherein the perimeter of said first rubber block is confined within the perimeter of said central block.

3. A block for stamping as claimed in claim 1 wherein said central block further comprises one or more longitudinal extending finger grooves.

4. A block for stamping as claimed in claim 1 wherein said central block is preferably wood.

5. A block for stamping as claimed in claim 1 wherein said central block further comprises a second flat surface opposed to and parallel with said first substantially flat surface.

6. A block for stamping as claimed in claim 5 further comprising a second rubber block comprising at least two opposing flat sides, said first flat side being secured to a second flat surface of said block and said opposed second flat side of said second rubber block being carvable by a carving tool, the carving tool adapted to create surface depressions in said second flat side of said second rubber block while leaving intact the non-carved surface of said second flat side of said second rubber block.

7. A block for stamping as claimed in claim 6 wherein the perimeter of said second rubber block is confined within the perimeter of said central block.

8. A block for stamping as claimed in claim 7 wherein the surface area of said first rubber block and said second rubber block are smaller in size than a conventional stamp pad.

9. A block for stamping as claimed in claim 1 wherein said rubber block is secured to said central block by any of the following: glue, tape, Velcro® fastener, or other adhesive.

10. A block for stamping as claimed in claim 6 wherein said rubber block is provided with a thin overlayer of rubber of a contrasting color to said underlayment of rubber of said rubber block.

11. A block for stamping as claimed in claim 1 wherein the bottom of said central block is provided with a frictional plate.

12. A block for stamping as claimed in claim 11 wherein said frictional plate is a second rubber block.

13. A block for stamping as claimed in claim 12 wherein said second rubber block is recessed inwardly from the perimeter of said central block.

14. A block for stamping as claimed in claim 12 wherein said second rubber block is comprised of least two opposing flat sides, said first flat side of said second rubber block being secured to a second flat surface of said central block and said opposed second flat side of said second rubber block being carvable by a carving tool, the carving tool adapted to create surface depressions in said second flat side of said second rubber block while leaving intact the non-carved surface of said second flat side of said second rubber block.

15. A block for stamping as claimed in claim 14 wherein said central block is about the size of a hand.

16. A block for stamping as claimed in claim 14 wherein said first and sand second rubber blocks are inwardly recessed within the perimeter of said central block.

17. A block for stamping as claimed in claim 14 wherein at least one edge of said central block is provided with a finger groove.

18. A block for stamping as claimed in claim 17 wherein said central block is provided with a pair of opposed finger grooves.

19. A block for stamping as claimed in claim 14 wherein the surface area of said rubber block is about the size of a conventional ink pad.

20. A block for stamping as claimed in claim 14 wherein the top surface of said rubber block is provided with an extra, thin layer of rubber of a distinct color to the rubber block.
